(19) United States
(12) Patent Application Publication
(10) Pub. No.: US 2025/0306745 A1
(43) Pub. Date: Oct. 2, 2025

(54) METHOD OF ADJUSTING TRANSPORT CONFIGURATION

(71) Applicant: DEKA Products Limited Partnership, Manchester, NH (US)

(72) Inventors: Thomas A. DOYON, Manchester, NH (US); Tania M.F. ZIRN, Chester, NH (US); Constance D. Pitenis, Hooksett, NH (US)

(21) Appl. No.: 18/617,995

(22) Filed: Mar. 27, 2024

(51) Int. Cl. G06F 3/04845; G06F 9/451

(52) U.S. Cl. CPC G06F 3/04845; G06F 9/451

(57) ABSTRACT

Disclosed is a method of adjusting transport configuration that includes detecting an input respecting a first icon on a home display. If the input has a first alignment relative to the first icon, then the method includes replacing the primary display with a secondary display. If the input has a second alignment relative to the first icon, then the method includes enabling detecting a second input respecting a second icon.

### CROSS REFERENCE TO RELATED APPLICATION(S)

None.

### RESERVATION OF COPYRIGHTS

Portions of the disclosure of this document contain material that is subject to copyright protection. The copyright owner has no objection to any reproduction of the document or disclosure as it appears in official records, but reserves all remaining rights under copyright.

### BACKGROUND

The present disclosure relates to mobility devices or transports and, more particularly, to a graphical user interface and controls for adjusting the configuration and maintaining safety of a mobility device, in particular, the seating thereof.

A wide range of devices and methods are known for transporting human subjects who experience physical incapacitation. Users of such devices spend on average 8-14 hours in them on a daily basis. Extended time in a static upright position can increase the likelihood of pressure ulcers, skin tears, skeletal deformities (specifically kyphosis or “C” curve posture), impaired respiration and digestion from forward flexed postures, joint contractures, pain and discomfort, agitation, decreased mobility, and falls, which can result in injuries. For persons with physical disabilities and generalized muscle weakness, the discomfort and pain from daily sitting can be chronic and debilitating. This can lead to reduced participation in daily activities including, work, education, and recreation.

Great strides have been made in mobility device seating, namely, greater flexibility in seating configurations. However, controls for achieving desired seating configurations remain challenging, particularly in terms of ease of use. One challenge is readily locating controls for adjusting particular segments of a seat. Another challenge is limiting the physical demands needed for articulating the controls.

While user comfort with mobility devices is important, comfort cannot compromise safety. Some seating configurations may be stable at rest, but less so, hence unsuitable for mobility or transport. Accordingly, preventing a mobility device from moving while in an unsuitable configuration is desirable. Since unsuitability for transport may not be readily apparent to a user, informing users that the configuration is unsuitable with specificity (i.e. leg rest segment extended too far), hence what should be adjusted to render the device stable for transport also is desirable.

What is needed is a graphical user interface for adjusting transport configuration, specifically the seating configuration thereof, including a display that represents a current configuration and the dynamic stability thereof, affords ease of selection of seating segments to be adjusted, input signals for accomplishing the adjustment, and responds to input generally corresponding to the signals for adjusting the segments.

### SUMMARY OF THE INVENTION

The invention is a graphical user interface for adjusting transport configuration, specifically the seating configuration thereof, including a display that represents a current configuration and the dynamic stability thereof, affords ease of selection of seating segments to be adjusted, input signals for accomplishing the adjustment, and responds to input generally corresponding to the signals for adjusting the segments.

An embodiment of a method of adjusting transport configuration configured according to principles of the invention includes detecting an input respecting a first icon on a home display. If the input has a first alignment relative to the first icon, then the method includes replacing the primary display with a secondary display. If the input has a second alignment relative to the first icon, then the method includes enabling detecting a second input respecting a second icon.

The invention provides improved elements and arrangements thereof, for the purposes described, which are inexpensive, dependable and effective in accomplishing intended purposes of the invention.

Other features and advantages of the invention will become apparent from the following description of the preferred embodiments, which refers to the accompanying drawings.

### BRIEF DESCRIPTION OF THE DRAWINGS

The invention is described in detail below with reference to the following figures, throughout which similar reference characters denote corresponding features consistently, wherein:

FIG. 1 is a top, right side elevational detail view of an embodiment of a controller for a transport configured according to principles of the invention; and

FIGS. 2-5C are graphical representations of embodiments of a display configured according to principles of the invention.

### DETAILED DESCRIPTION OF PREFERRED EMBODIMENTS

The examples shown in drawings are presented to demonstrate examples of the disclosure. The drawings are illustrative and non-limiting. In the drawings, for illustrative purposes, the size of some of the elements may be exaggerated and not drawn to a particular scale. Additionally, elements shown within the drawings that have the same numbers may be identical elements or may be similar elements, depending on the context.

Where the term “comprising” is used in the present description and claims, it does not exclude other elements or steps. Where an indefinite or definite article is used when referring to a singular noun, e.g., “a”, “an”, or “the”, this includes a plural of that noun unless something otherwise is specifically stated. Hence, the term “comprising” should not be interpreted as being restricted to the items listed thereafter; it does not exclude other elements or steps, and so the scope of the expression “a device comprising items A and B” should not be limited to devices consisting only of components A and B. Furthermore, to the extent that the terms “includes”, “has”, “possesses”, and the like are used in the present description and claims, such terms are intended to be inclusive in a manner similar to the term “comprising,” as “comprising” is interpreted when employed as a transitional word in a claim.

Furthermore, the terms “first”, “second”, “third”, and the like, whether used in the description or in the claims, are provided to distinguish between similar elements and not necessarily to describe a sequential or chronological order. It is to be understood that the terms so used are interchangeable under appropriate circumstances (unless clearly disclosed otherwise) and that the aspects of the disclosure described herein are capable of operation in other sequences and/or arrangements than are described or illustrated herein.

In the following description, numerous specific details are set forth to provide a thorough understanding of various aspects and arrangements. It will be recognized, however, that the techniques described herein can be practiced without one or more of the specific details, or with other methods, components, materials, etc. In other instances, well known structures, materials, or operations may not be shown or described in detail to avoid obscuring certain aspects.

Reference throughout this specification to “an aspect,” “an arrangement,” “a configuration,” or “an example” indicates that a particular feature, structure, or characteristic is described. Thus, appearances of phrases such as “in one aspect,” “in one arrangement,” “in a configuration,” “in some examples,” or the like in various places throughout this specification do not necessarily each refer to the same aspect, feature, configuration, example, or arrangement. Furthermore, the particular features, structures, and/or characteristics described may be combined in any suitable manner.

To the extent used in the present disclosure and claims, the terms “component,” “system,” “platform,” “layer,” “selector,” “interface,” and the like are intended to refer to a computer-related entity or an entity related to an operational apparatus with one or more specific functionalities, wherein the entity may be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server itself can be a component. One or more components may reside within a process and/or thread of execution and a component may be localized on one computer and/or distributed between two or more computers. In addition, components may execute from various computer-readable media, device-readable storage devices, or machine-readable media having various data structures stored thereon. The components may communicate via local and/or remote processes such as in accordance with a signal having one or more data packets (e.g., data from one component interacting with another component in a local system, a distributed system, and/or across a network such as the Internet with other systems via the signal). As another example, a component can be an apparatus with specific functionality provided by mechanical parts operated by electric or electronic circuitry, which may be operated by a software or firmware application executed by a processor, wherein the processor can be internal or external to the apparatus and executes at least a part of the software or firmware application. As yet another example, a component can be an apparatus that provides specific functionality through electronic components without mechanical parts; the electronic components can include a processor therein to execute software or firmware that confers at least in part the functionality of the electronic components.

To the extent used in the subject specification, terms such as “store,” “storage,” “data store,” data storage,” “database,” and the like refer to memory components, entities embodied in a memory, or components comprising a memory. It will be appreciated that the memory components described herein can be either volatile memory or nonvolatile memory, or can include both volatile and nonvolatile memory.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A, X employs B, or X employs both A and B, then “X employs A or B” is satisfied under any of the foregoing instances. Moreover, articles “a” and “an” as used in the subject disclosure and claims should generally be construed to mean “one or more” unless specified otherwise or clear from context to be directed to a singular form.

The words “exemplary” and/or “demonstrative,” to the extent used herein, mean serving as an example, instance, or illustration. For the avoidance of doubt, the subject matter disclosed herein is not limited by disclosed examples. In addition, any aspect or design described herein as “exemplary” and/or “demonstrative” is not necessarily to be construed as preferred or advantageous over other aspects or designs, nor is it meant to preclude equivalent exemplary structures and techniques. Furthermore, to the extent that the terms “includes,” “has,” “contains,” and other similar words are used in either the detailed description or the claims, such terms are intended to be inclusive, in a manner similar to the term “comprising” as an open transition word, without precluding any additional or other elements.

As used herein, the term “infer” or “inference” refers generally to the process of reasoning about, or inferring states of, the system, environment, user, and/or intent from a set of observations as captured via events and/or data. Captured data and events can include user data, device data, environment data, data from sensors, application data, implicit data, explicit data, etc. Inference can be employed to identify a specific context or action or can generate a probability distribution over states of interest based on a consideration of data and events, for example.

The disclosed subject matter can be implemented as a method, apparatus, or article of manufacture using standard programming and/or engineering techniques to produce software, firmware, hardware, or any combination thereof to control a computer to implement the disclosed subject matter. The term “article of manufacture,” to the extent used herein, is intended to encompass a computer program accessible from any computer-readable device, machine-readable device, computer-readable carrier, computer-readable media, or machine-readable media. For example, computer-readable media can include, but are not limited to, a magnetic storage device, e.g., hard disk; floppy disk; magnetic strip(s); an optical disk (e.g., compact disk (CD), digital video disc (DVD), Blu-ray Disc (BD)); a smart card; a flash memory device (e.g., card, stick, key drive); a virtual device that emulates a storage device; and/or any combination of the above computer-readable media.

Generally, program modules include routines, programs, components, data structures, etc., that perform particular tasks or implement particular abstract data types. The illustrated aspects of the subject disclosure may be practiced in distributed computing environments where certain tasks are performed by remote processing devices that are linked through a communications network. In a distributed computing environment, program modules can be located in both local and remote memory storage devices.

Computing devices can include at least computer-readable storage media, machine-readable storage media, and/or communications media. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data, or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media that can be used to store desired information. In this regard, the terms “tangible” or “non-transitory” herein as applied to storage, memory, or computer-readable media, are to be understood to exclude only propagating transitory signals per se as modifiers, and do not exclude any standard storage, memory, or computer-readable media that are not only propagating transitory signals per se.

Computer-readable storage media can be accessed by one or more local or remote computing devices, e.g., via access requests, queries, or other data retrieval protocols, for a variety of operations with respect to the information stored by the medium.

A system bus, as may be used herein, can be any of several types of bus structure that can further interconnect to a memory bus (with or without a memory controller), a peripheral bus, and a local bus using any of a variety of commercially available bus architectures. A database, as may be used herein, can include basic input/output system (BIOS) that can be stored in a non-volatile memory such as ROM, EPROM, or EEPROM, with BIOS containing the basic routines that help to transfer information between elements within a computer, such as during startup. RAM can also include a high-speed RAM such as static RAM for caching data.

As used herein, a computer can operate in a networked environment using logical connections via wired and/or wireless communications to one or more remote computers. The remote computer(s) can be a workstation, server, router, personal computer, portable computer, microprocessor-based entertainment appliance, peer device, or other common network node. Logical connections depicted herein may include wired/wireless connectivity to a local area network (LAN) and/or larger networks, e.g., a wide area network (WAN). Such LAN and WAN networking environments are commonplace in offices and companies, and facilitate enterprise-wide computer networks, such as intranets, any of which can connect to a global communications network, e.g., the Internet.

When used in a LAN networking environment, a computer can be connected to the LAN through a wired and/or wireless communication network interface or adapter. The adapter can facilitate wired or wireless communication to the LAN, which can also include a wireless access point (AP) disposed thereon for communicating with the adapter in a wireless mode.

When used in a WAN networking environment, a computer can include a modem or can be connected to a communications server on the WAN via other means for establishing communications over the WAN, such as by way of the Internet. The modem, which can be internal or external, and a wired or wireless device, can be connected to a system bus via an input device interface. In a networked environment, program modules depicted herein relative to a computer or portions thereof can be stored in a remote memory/storage device.

When used in either a LAN or WAN networking environment, a computer can access cloud storage systems or other network-based storage systems in addition to, or in place of, external storage devices. Generally, a connection between a computer and a cloud storage system can be established over a LAN or a WAN, e.g., via an adapter or a modem, respectively. Upon connecting a computer to an associated cloud storage system, an external storage interface can, with the aid of the adapter and/or modem, manage storage provided by the cloud storage system as it would other types of external storage. For instance, the external storage interface can be configured to provide access to cloud storage sources as if those sources were physically connected to the computer.

As employed in the subject specification, the term “processor” can refer to substantially any computing processing unit or device comprising, but not limited to comprising, single-core processors; single-core processors with software multithread execution capability; multi-core processors; multi-core processors with software multithread execution capability; multi-core processors with hardware multithread technology; vector processors; pipeline processors; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a state machine, a discrete gate or transistor logic, discrete hardware components, or any combination thereof designed to perform the functions described herein. Processors can exploit nano-scale architectures such as, but not limited to, molecular and quantum-dot based transistors, switches, and gates, in order to optimize space usage or enhance performance of user equipment. A processor may also be implemented as a combination of computing processing units. For example, a processor may be implemented as one or more processors together, tightly coupled, loosely coupled, or remotely located from each other. Multiple processing chips or multiple devices may share the performance of one or more functions described herein, and similarly, storage may be effected across a plurality of devices. A processor may be implemented to reside in a cloud-based network such as, e.g., the Internet.

The actions of a method or algorithm described in connection with the arrangements disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other known form of storage medium. A storage medium may be coupled to the processor such that the processor can read information from, and write information to, the storage medium. In the alternative, the storage medium may be integral to the processor. The processor and the storage medium may reside in an ASIC. The ASIC may reside in functional equipment such as, e.g., a computer, a robot, a user terminal, a mobile telephone or tablet, a car, or an IP camera. In the alternative, the processor and the storage medium may reside as discrete components in such functional equipment. Additionally or alternatively, at least one of the processor and/or the storage medium may reside in a cloud-based network such as, e.g., the Internet.

Configurations of the present teachings are directed to computer systems for accomplishing the methods discussed in the description herein, and to computer readable media containing programs for accomplishing these methods. The raw data and results can be stored for future retrieval and processing, printed, displayed, transferred to another computer, and/or transferred elsewhere. Communications links can be wired or wireless, for example, using cellular communication systems, military communications systems, and satellite communications systems. Parts of the system can operate on a computer having a variable number of CPUs. Other alternative computer platforms can be used.

The present configuration is also directed to software/firmware/hardware for accomplishing the methods discussed herein, and computer readable media storing software for accomplishing these methods. The various modules described herein can be accomplished on the same CPU, or can be accomplished on different CPUs. In compliance with the statute, the present configuration has been described in language more or less specific as to structural and methodical features. It is to be understood, however, that the present configuration is not limited to the specific features shown and described, since the means herein disclosed comprise preferred forms of putting the present configuration into effect.

Methods can be, in whole or in part, implemented electronically. Signals representing actions taken by elements of the system and other disclosed configurations can travel over at least one live communications network. Control and data information can be electronically executed and stored on at least one computer-readable medium. The system can be implemented to execute on at least one computer node in at least one live communications network. Common forms of at least one computer-readable medium can include, for example, but not be limited to, a floppy disk, a flexible disk, a hard disk, magnetic tape, or any other magnetic medium, a compact disk read only memory or any other optical medium, punched cards, paper tape, or any other physical medium with patterns of holes, a random access memory, a programmable read only memory, and erasable programmable read only memory (EPROM), a Flash EPROM, or any other memory chip or cartridge, or any other medium from which a computer can read. Further, the at least one computer readable medium can contain graphs in any form, subject to appropriate licenses where necessary, including, but not limited to, Graphic Interchange Format (GIF), Joint Photographic Experts Group (JPEG), Portable Network Graphics (PNG), Scalable Vector Graphics (SVG), and Tagged Image File Format (TIFF).

Various arrangements are described herein. For simplicity of explanation, the methods or algorithms are depicted and described as a series of steps or actions. It is to be understood and appreciated that the various arrangements are not limited by the actions illustrated and/or by the order of actions. For example, actions can occur in various orders and/or concurrently, and with other actions not presented or described herein. Furthermore, not all illustrated actions may be required to implement the methods. In addition, the methods could alternatively be represented as a series of interrelated states via a state diagram or events. Additionally, the methods described hereafter are capable of being stored on an article of manufacture, as defined herein, to facilitate transporting and transferring such methodologies to computers.

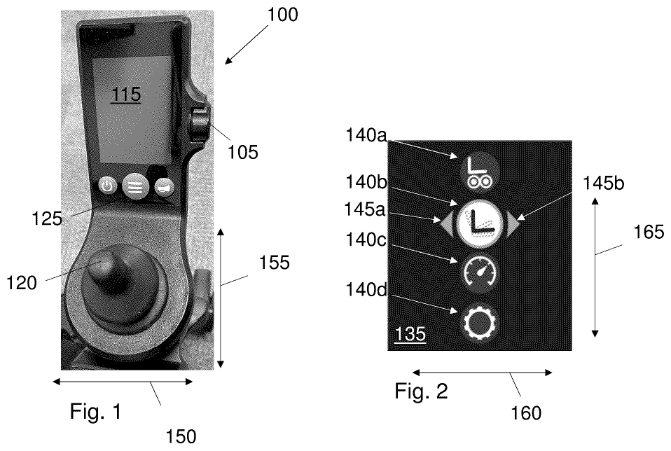

Referring to FIG. 1, the invention pertains to a control system 100 for a transport or mobility device (not shown) comparable to that disclosed in U.S. Pat. No. 10,908,045 issued Feb. 2, 2021 to Deka Research & Development Corp, the contents of which patent are incorporated herein. Control system 100 relies on a processor (not shown) that is configured for executing computer instructions for a graphical user interface (GUI) with a display 115 that presents users with images, menus and other visual indicators. The GUI is responsive to user input and controls operations of the mobility device in accordance therewith. Preferably, user input is exercised with a joystick 120 for navigating selections presented on display 115 and operating the transport according to the selections. User input also may be registered through turning a speed wheel 105.

Referring to FIG. 2, when a user activates the menu button 125, processor (not shown) executes GUI 115 and shows a primary display 135 having multiple icons 140a-d. Preferably, each icon 140 is associated with and can be selected or manipulated to invoke a unique set of functions. The functions include, but are not limited to: mode selection, associated with an icon 140a; seat adjustment, associated with an icon 140b; speed control, associated with an icon 140c; and device settings, associated with an icon 140d.

Preferably, primary display 135 is rendered so as to highlight one of icons 140, for example with indicia 145a and 145b proximate to icon 140b, so as to signal the user that input is detectable relative to highlighted icon 140b. Indicia 145 also may signal the user as to an alignment along which an input device, such as joystick 120, may be articulated for selecting a function and accessing related secondary displays, as described below.

Referring also to FIG. 1, preferably, GUI 115 is configured to recognize articulation of the joystick 120 or comparable device along a first alignment 150 and a second alignment 155, which respectively correspond with third alignment 160 and fourth alignment 165. Thus, urging joystick 120 to describe second alignment 155 would be recognized by GUI 115 as an instruction to move selection along fourth alignment 165 to a different one of icons 140. For example, urging joystick 120 toward the bottom of the page along second alignment 155 would be recognized by GUI 115 as an instruction to move selection along fourth alignment 165 from, in this case, icon 140b toward the bottom of the page and select icon 140c. Preferably, such selection would be accompanied by highlighting icon 140c and eliminating any highlighting relative to the previously-highlighted icon, icon 140b in this case.

Urging joystick 120 to describe first alignment 150 would be recognized by GUI 115 as an instruction to move selection along third alignment 160 or enable employing the unique set of functions associated with the icon selected, in this case icon 140b. For example, urging joystick 120 along first alignment 150 would be recognized by GUI 115 as an instruction to move selection from highlighted icon 140b along third alignment 160 to view one or more secondary displays, preferably like a carousel, associated therewith. Each secondary display provides for selecting and controlling features or functions associated with the selected icon.

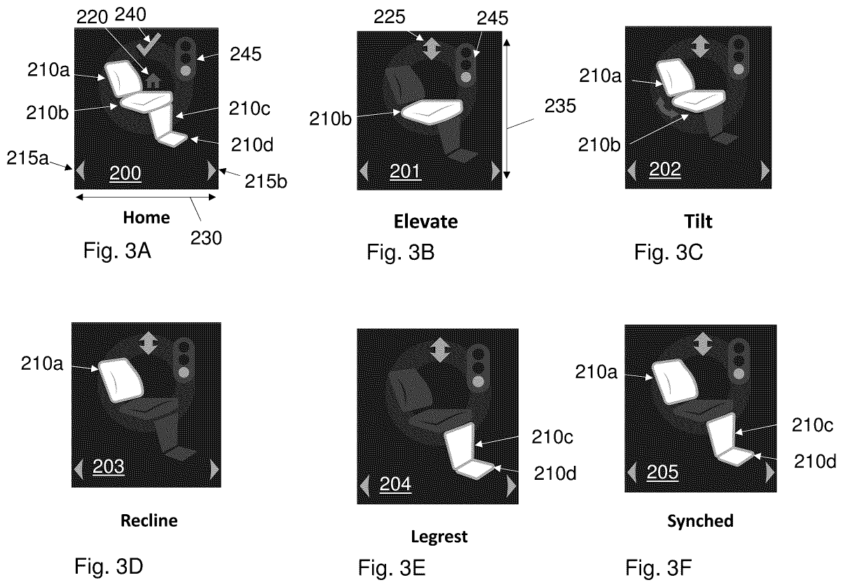

Referring to FIG. 3A, preferably, a first secondary display in the carousel of secondary displays associated with selected icon 140b is a home display 200. Preferably, home display 200 displays a house-shaped icon 220 or appropriate icon for signaling the user that the secondary display displayed is a home display. Home displays display an overview of the functions that fall within the purview of the selected icon, in this case, for icon 140b respecting seat configuration. Accordingly, home display 200 displays all configurable segments 210a-d of seating.

Preferably, home display 200 is rendered with indicia 215a and 215b to signal the user as to an alignment along which an input device, such as joystick 120, may be articulated for accessing or navigating to other secondary displays of the carousel. For example, urging joystick 120 along second alignment 150 would be recognized by GUI 115 as an instruction to move selection from the current secondary display along a fifth alignment 230 to another secondary display.

Referring also to FIGS. 3B-3F, regarding seat configuration, other secondary displays may pertain to, but are not limited to individual segments 210 and/or combinations thereof, for addressing the following adjustments: elevate 201 for increasing/decreasing a height relative to the ground of segment 210b (FIG. 3B); tilt 202 for increasing/decreasing the angle relative to the ground of segment 210a while maintaining the relationship with segment 210b (FIG. 3C); recline 203 for increasing/decreasing the angle relative to the ground of segment 210a without maintaining the relationship with segment 210b (FIG. 3D); leg rest 204 for increasing/decreasing the angle relative to segment 210b of segment 210c while maintaining the relationship with segment 210d (FIG. 3E); and synched 205 for increasing/decreasing the angle relative to segment 210b of segment 210a and segment 210c while maintaining the relationship between segment 210c and segment 210d FIG. 3F).

Referring to FIG. 3B, as with any of secondary displays 201-205, display 201 includes indicia 225 that signals to the user that: an adjustment may be effected through the current display; and an alignment along which an input device, such as joystick 120, may be articulated to effect the adjustment. For example, to effect the adjustment commensurate with the selected secondary display, in this case display 201, the user urges joystick 120 along first alignment 155 which GUI 115 would recognize as an instruction along a sixth alignment 235 for increasing/decreasing the height relative to the ground of segment 210b. If the instruction is toward the top of the page along sixth alignment 235, then the instruction would be understood as increasing the height and vice versa.

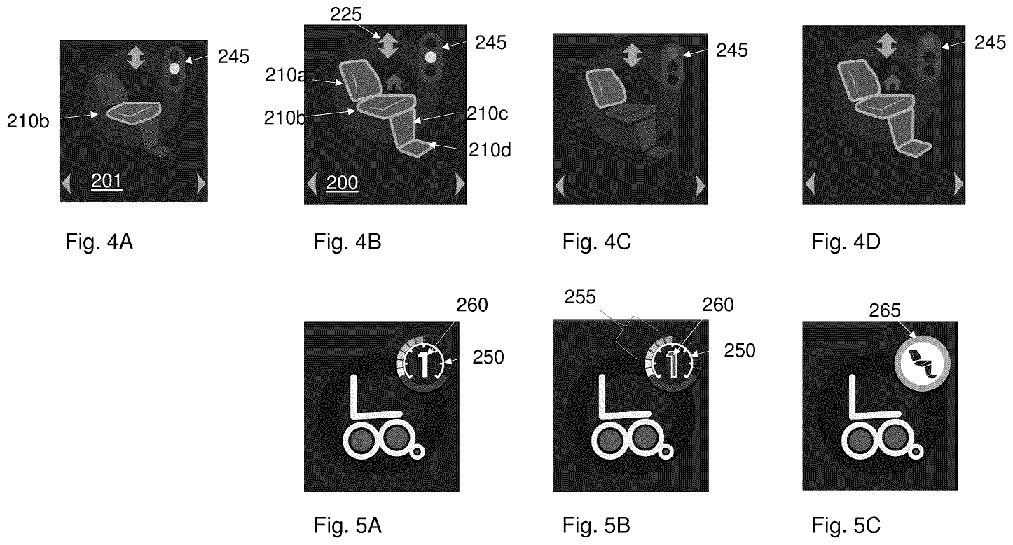

Referring also to FIG. 4A, while in FIG. 3B segment 210b is rendered as a generally white cushion with blue outlining, which would be indicative of defining a “home” position, in FIG. 4A the same segment 210b is rendered generally dark blue with the same outlining. The color change in segment 210b between FIGS. 3B and 4A signals to the user that the configuration of segment 210b differs from its “home” position. While any colors or rendering techniques may be employed, any change in appearance or other indicator may be used that aids the user in appreciating that one or more segments on a secondary display are not in the “home” position.

Similarly, in FIG. 3A, home display 200 renders all segments 210a-d as white cushions with blue outlining, signifying that all segments 210a-d are in the “home” position. FIG. 4B, on the other hand, renders all segments 210a-d as blue cushions with blue outlining, signifying that at least one of segments 210a-d are not in the “home” position. Alternatively, when not all of segments 210a-d are in the “home” position, home display 201 may be rendered such that only the particular ones of segment(s) 210a-d that are/is not in the “home” position is/are rendered as a blue cushion(s).

Consistent with the above, as shown in FIG. 3A, the invention also provides for signaling the user when all segments 210a-d are in the “home” position by rendering home screen 201 with an indicium 240, preferably in the form of a check mark. As shown in FIG. 4B, when not all of segments 210a-d are in the “home” position, home display 200 may be rendered with an indicium 225, indicating adjustment is available or may be needed for achieving the “home” position. In this situation, the user may articulate joystick 120 along first alignment 155 which GUI 115 would recognize as an instruction along sixth alignment 235. Unlike in the other secondary displays, articulating joystick 120 in either direction along sixth alignment 235 would affect moving segments 210a-d into the “home” position that are not currently in the “home” position.

Referring to FIGS. 3A, 4B and 4D, an embodiment configured according to principles of the invention also provides for signaling the user as to whether the speed at which the transport may travel is or will be affected based on the safety of moving the transport in a current seating configuration. Preferably, this signaling is achieved by rendering on any of the secondary displays an indicium 245, preferably resembling a conventional traffic signal wherein: a “green light” configuration, as shown in FIG. 3A, signals that the configuration of the transport can go full speed; a “yellow light” configuration, as shown in FIG. 4B, signals that the configuration of the transport is such that the speed at which the transport is allowed to travel is or will be reduced; and a “red light” configuration, as shown in FIG. 4D, signals that the configuration of the transport is such that the transport is placed in “drive lock” status wherein the user will not be able to instruct the transport to traverse.

Referring to FIG. 5C, another indication of the “drive lock” status may be shown via an indicium 255 that generally resembles the seating components of the transport, thus signaling that the seating configuration is the reason for the drive lockout. Other colors or rendering techniques may be applied.

Referring to FIGS. 5A and 5B, the invention provides a virtual gauge 250 for visualizing an amount of full speed that a user desires for the transport to travel as selected or controlled via speed wheel 105 (FIG. 1). Rendering central indicium 260 in a white color, as shown in FIG. 5A, indicates that the transport is permitted to travel at maximum speed. Rendering central indicium 260 in a blue color, as shown in FIG. 5B, indicates that the transport is not permitted to travel at maximum speed. Additionally, blue segments 255 on a circumferentially-arranged dial indicium show the reduced amount of speed at which the transport is permitted to travel relative to the maximum speed the transport can travel. Other colors or rendering techniques may be applied.

While the principles of the invention have been described herein, the foregoing description is only an example and not a limitation on the scope of the invention. Other embodiments are contemplated within the scope of the present invention in addition to the exemplary embodiments shown and described herein. Modifications and substitutions by one of ordinary skill in the art are within the scope of the present invention. The invention is not limited to the particular embodiments described and depicted herein, rather only to the following claims.

We claim:

1. Method of adjusting transport configuration comprising:
detecting an input respecting a first icon on a home display; and
if the input has a first alignment relative to the first icon, then replacing the primary display with a secondary display;
else if the input has a second alignment relative to the first icon, then enabling detecting a second input respecting a second icon.

2. Method of claim 1 further comprising, prior to said detecting, highlighting the first icon on the primary display.

3. Method of claim 2 wherein said highlighting comprises: associating an indicium; rendering with a color; rendering brighter; rendering larger; and combinations thereof.

4. Method of claim 1, if the input has a second alignment relative to the first icon, further comprising replacing the primary display with a second primary display.

5. Method of claim 4 further comprising highlighting the second icon on the second primary display.

6. Method of claim 1 wherein the first icon and/or the second icon relate to: seat component configuration options; power off options; drive options; mode options; setting options; and combinations thereof.

7. Method of claim 1 further comprising:
detecting a second input; and
if the second input has a third alignment relative to the secondary display, then replacing the secondary display with another secondary display.

8. Method of claim 1 further comprising rendering the secondary display with an indicium pertaining to an operating limit and/or recommendation.

9. Method of claim 8 wherein the indicium resembles a traffic light.

10. Method of claim 1 wherein the secondary display comprises an image configured to resemble a seat component.

11. Method of claim 10 further comprising:
first rendering the secondary display with a first indicium when the seat component defines a first configuration; and/or
second rendering the secondary display with a second indicium when the seat component defines a second configuration.

12. Method of claim 11 wherein the first indicium is a first color and/or the second indicium is a second color.

13. Method of claim 10 further comprising:
detecting a second input; and
if the second input has a third alignment relative to the secondary display, then commanding moving the seat component.

14. Method of claim 13 wherein said moving is selected from: an elevation; a tilt; a recline; a leg rest; a “home” position; a synched mode; and combinations thereof.

15. Method of claim 13 wherein, if the third alignment is in a first direction, then said moving increases a difference between a first configuration and a second configuration, and if the third alignment is in a second direction, then said moving decreases the difference.

16. Method of claim 1, wherein the secondary display comprises an image configured to resemble a seat having multiple components, further comprising first rendering the secondary display with a first indicium when the components define a first configuration and/or second rendering the secondary display with a second indicium when the components define a second configuration.

17. Method of claim 16 wherein the first indicium is a first color and/or the second indicium is a second color.

18. Method of claim 16 further comprising:
detecting a second input; and
if the second input has a third alignment relative to the secondary display, then replacing the secondary display with another secondary display.

19. Method of claim 16 further comprising:
detecting a second input; and
if the second input has a third alignment relative to the secondary display, then commanding the components to assume the first configuration.

20. Method of claim 16 wherein said second rendering respects only components without the first configuration.
